(19) United States
(12) Patent Application Publication
(10) Pub. No.: US 2006/0272368 A1
(43) Pub. Date: Dec. 7, 2006

(54) Dual locking device

(76) Inventor: Chun Te Yu, Fusing Township (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 11/503,074

(22) Filed: Aug. 14, 2006

Related U.S. Application Data
(63) Continuation-in-part of application No. 10/792,875, filed on Mar. 5, 2004.

(51) Int. Cl. E05B 73/00

(52) U.S. Cl. 70/58

(57) ABSTRACT

A dual locking device comprises a housing, a switch member and two locking mechanisms. The switch member is arranged to be capable of moving between a first position and a second position with respect to the housing. The first locking mechanism is mounted on the switch member, and the second locking mechanism is mounted on the housing, wherein the switch member can be released for movement from the first position to the second position by either the first locking mechanism or the second locking mechanism.

### CROSS REFERENCE TO RELATED APPLICATION

This is a continuation-in-part application of the co-pending U.S. Ser. No. 10/792,875 application, filed on Mar. 5, 2004.

### TECHNICAL FIELD

The present invention relates to a locking device for a suitcase, in particular to a locking device with two locking mechanisms.

### BACKGROUND OF THE INVENTION

To prevent Customs or security inspectors from directly breaking a locked suitcase for inspection purposes, various locking techniques applied to suitcases regarding to the inspection issue are provided. A conventional padlock disclosed in U.S. Pub. No. 2004/0226323 mainly comprises a casing, a shackle, a locking mechanism, a latching tube and a stop member. The locking mechanism and the latching tube function as locking devices, which are provided for a suitcase owner and a suitcase inspector to unlock the padlock respectively by operating either the locking mechanism or the latching tube when such a padlock is applied to a suitcase. Therefore, the suitcase can be inspected easily without destroying the padlock or the suitcase.

Additionally, some suitcases are not suitable to use the foregoing padlock; therefore, another conventional locking device applied to such a suitcase is provided. U.S. Pat. No. 5,117,663 discloses a key lockable buckle, which can be applied to baggage. The key lockable buckle comprises a plug, a socket and a mechanism which is mounted on the socket for locking the plug and the socket by a key. However, the key lockable buckle provides only one lock function that only the key holder can unlock the buckle; therefore, the inspection problem of the baggage still exists.

Therefore, it would be advantages to provide a beneficial dual locking device for a suitcase owner and a suitcase inspector.

### SUMMARY OF INVENTION

The present invention is directed to a dual locking device that satisfies the needs mentioned above. The dual locking device comprises a housing, a switch member, a first locking mechanism and a second locking mechanism. The switch member is arranged to be capable of moving between a first position and a second position with respect to the housing. The first locking mechanism is mounted on the switch member and the second locking mechanism is mounted on the housing. Alternatively, the first locking mechanism can be mounted on the housing and the second locking mechanism can be mounted on the switch member. Therefore, the switch member can be released for movement from the first position to the second position by either the first locking mechanism or the second mechanism.

Further benefits and advantages of the present invention will become apparent after a careful reading of the detailed description with appropriate reference to the accompanying drawings.

### BRIEF DESCRIPTION OF DRAWINGS

FIG. 1 is an exploded perspective view of a dual locking device according to a first embodiment of the subject invention;

FIG. 2 is a cross-section view of the dual locking device in FIG. 1, showing a state in which the dual locking device is locked;

FIG. 3 is a cross-section view of the dual locking device in FIG. 1, showing a state in which the dual locking device is unlocked by a key;

FIG. 4 is a cross-section view of the dual locking device in FIG. 1, showing a state in which the dual locking device is unlocked by a combination;

FIG. 5 is a cross-section view of a dual locking device according to a second embodiment of the present invention, showing that the dual locking device is locked;

FIG. 6 is a cross-section view of the dual locking device in FIG. 5, showing that the dual locking device is unlocked by a key;

FIG. 7 is a cross-section view of the dual locking device in FIG. 5, showing that the dual locking device is unlocked by a combination;

FIG. 8 is an exploded perspective view of a dual locking device according to a third embodiment of the present invention;

FIG. 9 is a cross-section view of the dual locking device in FIG. 8, showing that the dual locking device is locked;

FIG. 9A shows connections between a retaining part and a protrusion of the dual locking device in FIG. 9;

FIG. 10 is a cross-section view of the dual locking device in FIG. 8, showing that the dual locking device is unlocked by a combination;

FIG. 11 is a cross-section view of the dual locking device in FIG. 8, showing that a key is inserted and rotated;

FIG. 11A shows connections between the retaining part and the protrusion of the dual locking device in FIG. 11;

FIG. 12 is a cross-section view of the dual locking device in FIG. 8, showing that the dual locking device is unlocked by the key;

FIG. 13 is an exploded perspective view of a dual locking device according to a fourth embodiment of the present invention;

FIG. 14 is a perspective assembly view of the dual locking device in FIG. 13, showing that a switch member is released to uncover a unlocking unit;

FIG. 15 is a cross-section view of the dual locking device in FIG. 13, showing that the dual locking device is locked;

FIG. 16 is a cross-section view of the dual locking device in FIG. 13, showing that the dual locking device is unlocked by a combination;

FIG. 17 is a cross-section view of the dual locking device in FIG. 13, showing that the dual locking device is unlocked by a key;

FIG. 18 is a perspective view of a dual locking device according to a fifth embodiment of the present invention, showing that a switch member is moved to a position uncovering an unlocking unit;

FIG. 19 is a perspective view of a dual locking device according to a sixth embodiment of the present invention, showing that a switch member is rotated to a position uncovering an unlocking unit;

FIG. 20 shows a dual locking device as a seventh embodiment of the present invention;

FIG. 21 is a cross-section view of the dual locking device in FIG. 20, showing that the dual locking device is unlocked by a combination; and

FIG. 22 is a cross-section view of the dual locking device in FIG. 20, showing that the dual locking device is unlocked by a key.

### DETAILED DESCRIPTION OF PREFERRED EMBODIMENTS

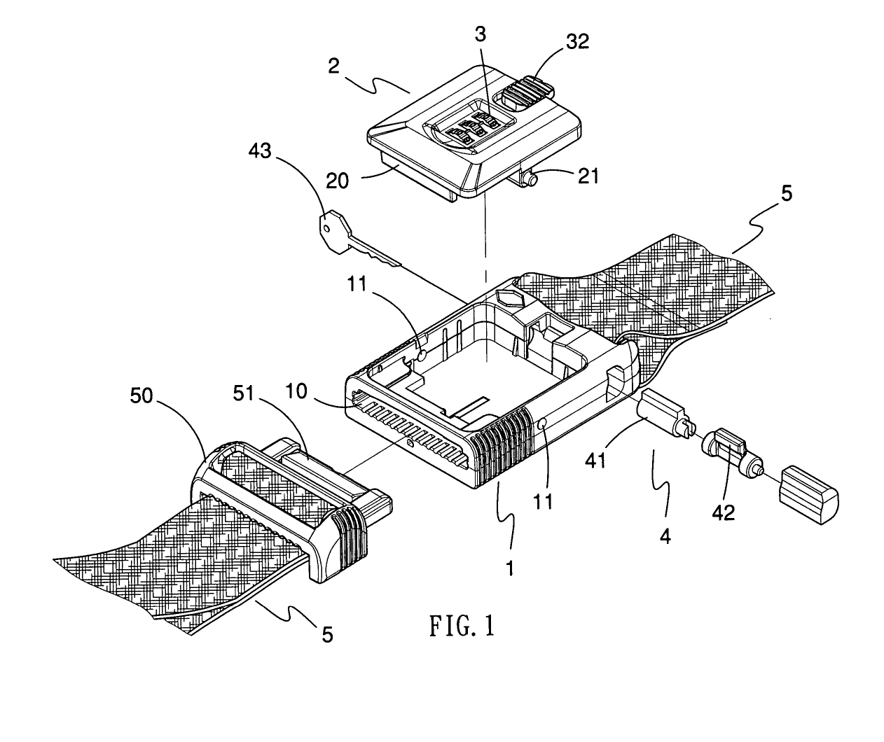

With reference to FIGS. 1 to 4, description will be made of a dual locking device according to a first embodiment of the present invention.

Referring to FIG. 1, the dual locking device, namely a woven strap lock, is available for a luggage-binding strap 5. The luggage-binding strap 5 is used to bind a luggage (not shown) and has a first end attached to a fastener 50 and a second end attached to the dual locking device. The dual locking device comprises a housing 1, a switch member 2, a first locking mechanism 3, and a second locking mechanism 4.

The housing 1 has a slot 10 for allowing insertion of the fastener 50 and has a pivot portion 11. The switch member 2 is movably connected with the pivot portion 11 so as to be rotatable about the pivot portion 11 between a first position and a second position with respect to the housing 1. In this example, the pivot portion 11 is a set of two opposite shaft holes, as shown in FIG. 1. The switch member 2 has two sides each having a shaft 21 pivotally mounted in the respective shaft hole 11 of the housing 1, thereby the switch member 2 can rotate about the pivot portion 11, namely the opposite shaft holes.

In accordance with the first embodiment, the first locking mechanism 3 is a combination lock mounted on the switch member 2; and the second locking mechanism 4 is a key lock mounted on the housing 1.

Moreover, the second locking mechanism 4, namely the key lock, includes a lock core 41 and a retaining part 42. The lock core 41 can be operated by a specific key 43 to drive the retaining part 42 to rotate.

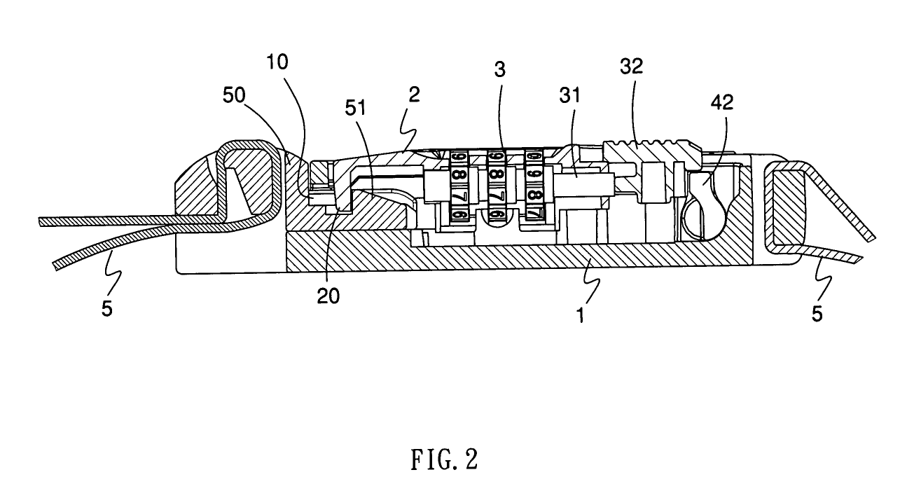

Referring to FIG. 2, the first locking mechanism 3, namely the combination lock, includes a movable shaft 31 and a press-button 32. Only if a set of unlocking codes is dialed so as to unlock the first locking mechanism 3, the press-button 32 can be pressed to release the switch member 2.

In FIG. 2, an insert 51 of the fastener 50 is inserted into the slot 10 of the housing 1 and is blocked by a locking portion 20 of the switch member 2 so that the fastener 50 can not be released from the housing 1. In the meantime, the retaining part 42 obstructs the press-button 32 and restricts the switch member 1 in the first position.

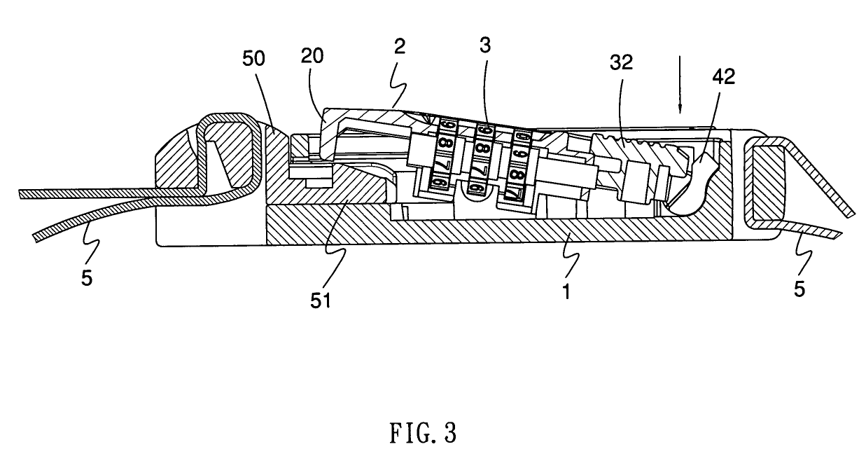

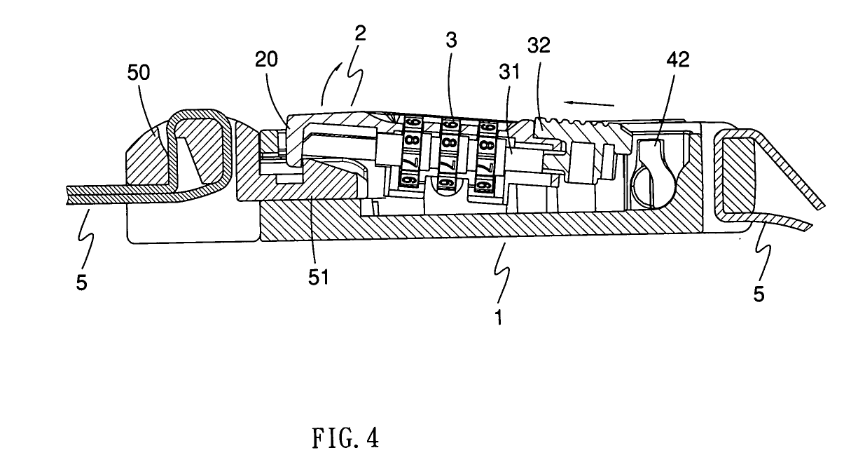

FIG. 3 shows that the retaining part 42 is rotated away from the press-button 32 by operating the key 43 via the second locking mechanism 4. Accordingly, the locking portion 20 of the switch member 2 can be released and move from the first position to the second position by operating the switch member 2. In FIG. 4, the shaft 31 of the first locking mechanism 3 is movable when the set of unlocking codes is dialed. Accordingly, the press-button 32 can be pushed away from the retaining part 42 so that the locking portion 20 of the switch member 2 can be released and move from the first position to the second position by operating the switch member 2.

As the two examples noted above, the switch member 2 can be swung or pressed to swing to the second position so as to release the locking portion 20 from the insert 51. In this state, the fastener 50 can then be pulled out from the housing 1. Accordingly, the switch member 2 can be released for movement from the first position to the second position for unlocking by either the first locking mechanism 3 or the second locking mechanism 4.

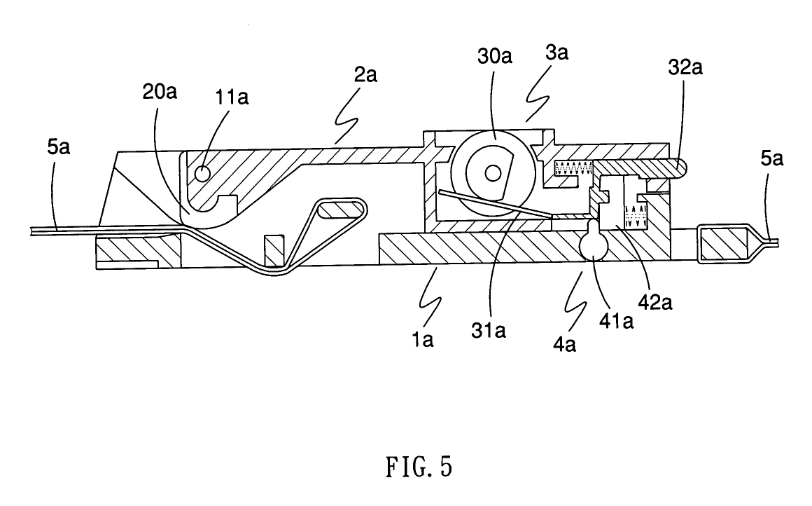

FIGS. 5 to 7 further show a dual locking device as a second embodiment of the present invention. The second embodiment is similar to the first embodiment of the present invention. In FIG. 5, the dual locking device, namely a woven strap lock, is available for a luggage-binding strap 5a. The luggage-binding strap 5a is used to bind a luggage (not shown). The dual locking device comprises a housing 1a, a switch member 2a, a first locking mechanism 3a, and a second locking mechanism 4a. The luggage-binding strap 5a is captured by the housing 1a, as shown in FIG. 5.

The housing 1a has a pivot portion 11a for connecting with the switch member 2a so that the switch member 2a can rotate about the pivot portion 11a between a first position and a second position with respect to the housing 1a.

In the second embodiment, similar with the first embodiment, the first locking mechanism 3a is a combination lock mounted on the switch member 2a; and the second locking mechanism 4a is a key lock mounted on the housing 1a.

The first locking mechanism 3a, namely the combination lock, includes a movable plate 31a and a press-button 32a. The movable plate 31a blocks the press-button 32a. Only if a set of unlocking codes is dialed so as to unlock the first locking mechanism 3a, the press-button 32a can be pressed to release the switch member 2a. Moreover, the second locking mechanism 4a, namely the key lock, includes a lock core 41a and a retaining part 42a. The lock core 41a can be operated by a specific key (not shown) to drive the retaining part 42a to move. In FIG. 5, the switch member 2a has a bottom formed with a locking portion 20a. When the switch member 2a is restricted in the first position in the result of the retaining part 42a obstructing the press-button 42a, the locking portion 20a of the switch member 2a presses the luggage-binding strap 5a.

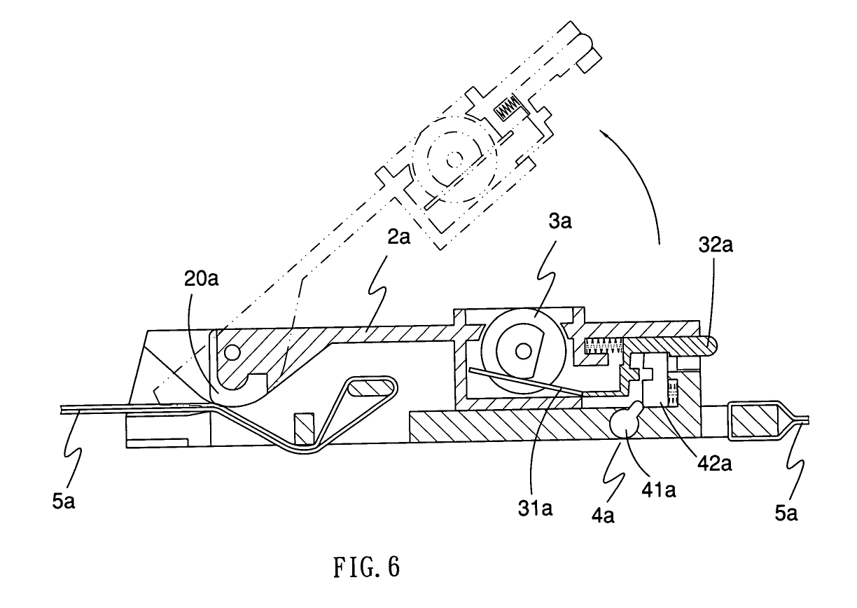

FIG. 6 shows that the retaining part 42a is moved away from the press-button 32a via the lock core 41a of the second locking mechanism 4a. In this state, the switch member 2a can be released and opened for movement to the second position. At the same time, the locking portion 20a of the switch member 2a releases the luggage-binding strap 5a. Accordingly, the switch member 2a can be released for movement from the first position to the second position by operating the second locking mechanism 4a.

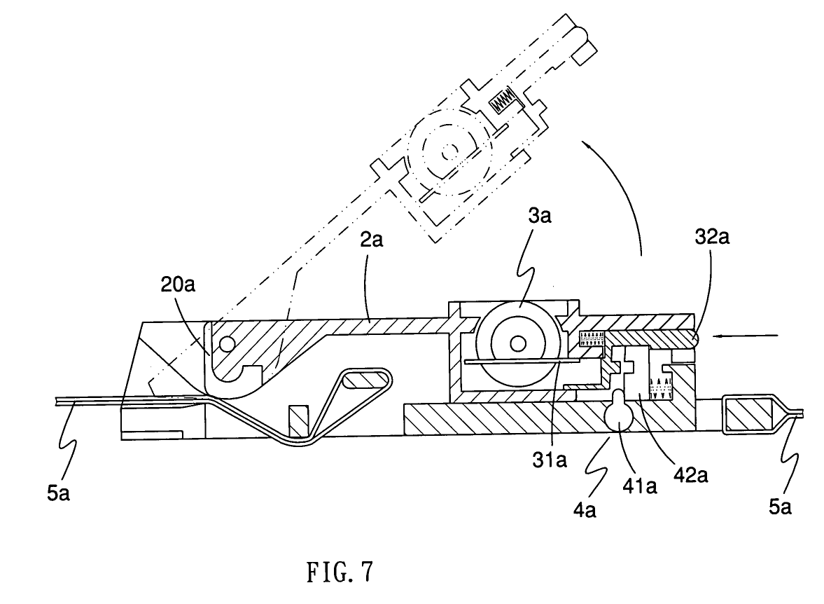

In FIG. 7, even though the retaining part 42a does not move by operating the lock core 41a of the second locking mechanism 4a, the plate 31a of the first locking mechanism 3a comes off the press-button 32a when the first locking mechanism 3a is unlocked by setting the unlocking codes. Therefore, the press-button 32a can be pushed regardless the retaining part 42a. After the press-button 32a moves, the switch member 2a can be released and opened for movement to the second position so as to make the locking portion 20a release the luggage-binding strap 5a. Accordingly, the switch member 2a can also be released for movement from the first position to the second position by the first locking mechanism 3a. Similarly to the first embodiment, the switch member 2a of the second embodiment can be released by either the first locking mechanism 3a or the second locking mechanism 4a.

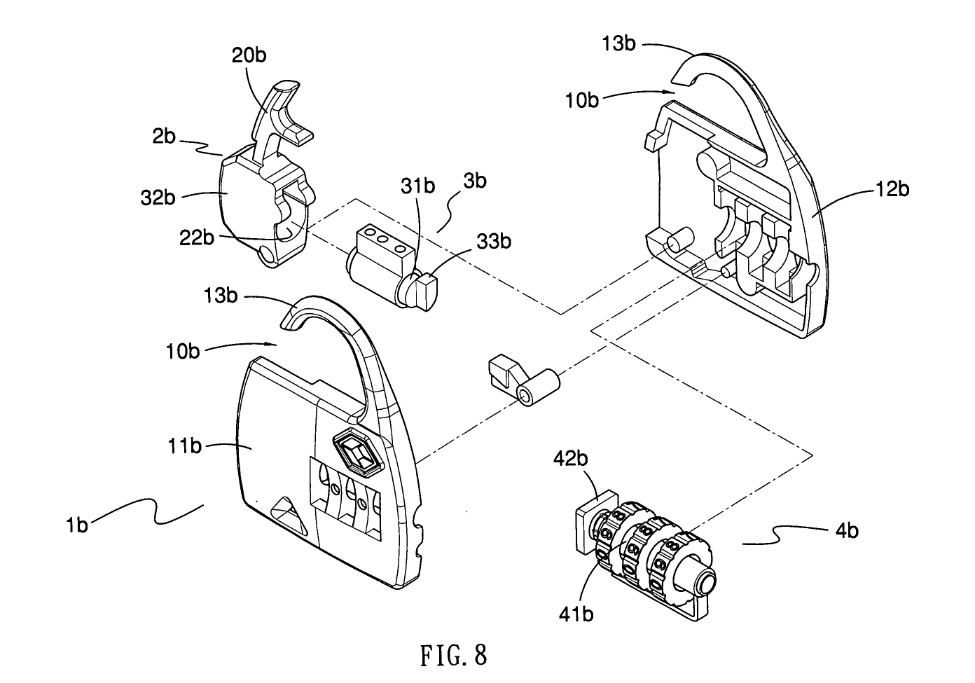

Additionally, a dual locking device as a third embodiment of the present invention is further shown in FIGS. 8 to 12. In FIG. 8, the dual locking device, namely a padlock, comprises a housing 1b, a switch member 2b, a first locking mechanism 3b and a second locking mechanism 4b. The housing 1b is formed by combining a first casing 11b and an opposite second casing 12b. A hook 13b is formed on the top of the housing 1b and a breach 10b is formed between the housing 1b and an end of the hook 12b.

The switch member 2b includes a press-button 32b and a locking portion 20b. A bottom of the press-button 32b is swingably mounted on the housing 1b and the press-button 32b has a side exposed to outside of the housing 1b. Moreover, the press button 32b defines with a recess 22b for receiving the first locking mechanism 3b. The locking portion 20b is connected with the press-button 32b. The switch member 2b can swing either to a first position for blocking the breach 10b by the locking portion 20b or a second position with respect to the housing 1b for opening the breach 10b only if the switch member 2b is released by either the first locking mechanism 3b or the second locking mechanism 4b.

In the third embodiment, contrary to the first embodiment, the first locking mechanism 3b is a key lock mounted on the switch member 2b; and the second locking mechanism 4b is a combination lock mounted on the housing 1b.

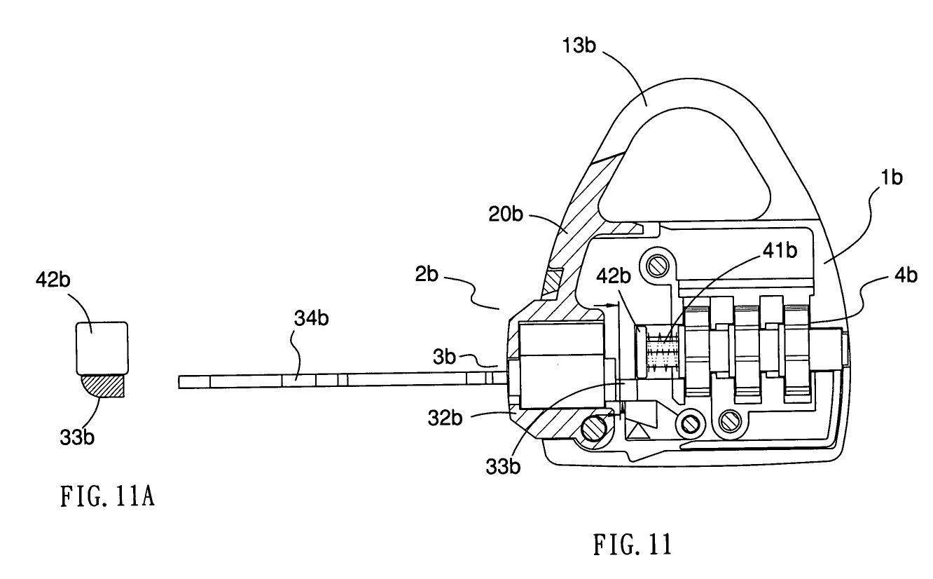

Referring again to FIGS. 8 and 11, the first locking mechanism 3b, 25 namely the key lock, includes a lock core 31b and a protrusion 33b. The lock core 31b can be operated by a specific key 34b to drive the protrusion 33b. Furthermore, the second locking mechanism 4b, namely the combination lock, includes a movable shaft 41b and a retaining part 42b. The movable shaft 41b blocks the protrusion 33b of the first locking mechanism 3b.

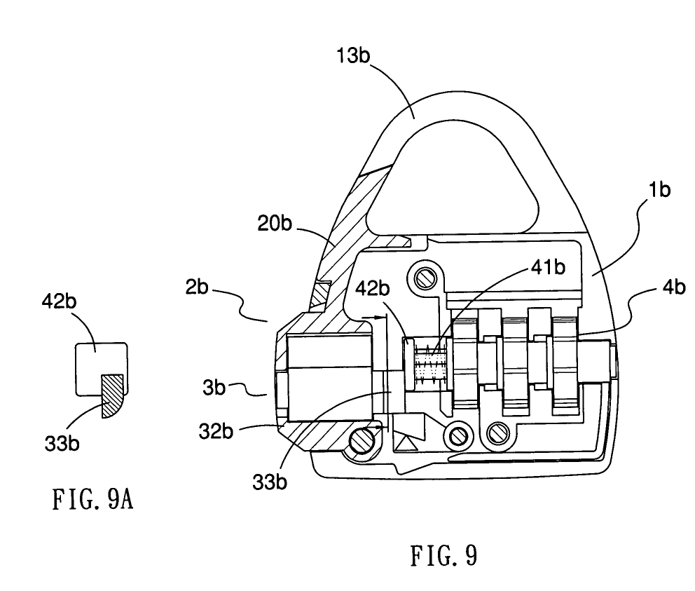

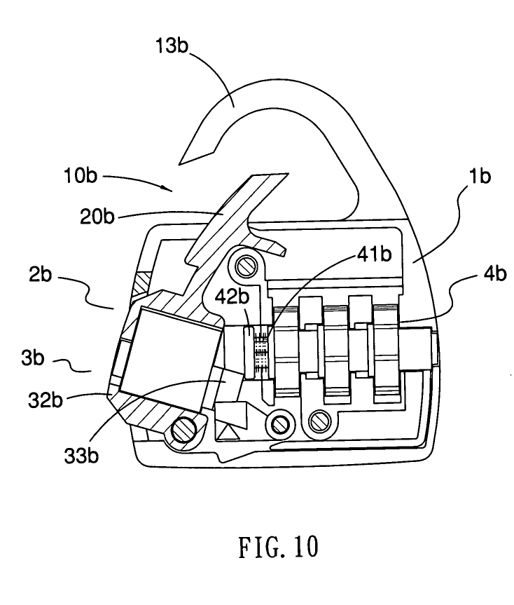

In FIG. 9 and FIG. 9A, when the second locking mechanism 4b is unlocked by setting a set of unlocking codes, the retaining part 42b can be then pressed by the protrusion 33b via the switch member 2b. In the meantime, the locking portion 20b can swing to the second position for opening the breach 10b, so as to release the switch member 2b, as shown in FIG. 10. Accordingly, the switch member 2b can be released for movement from the first position to the second position by the second locking mechanism 4b.

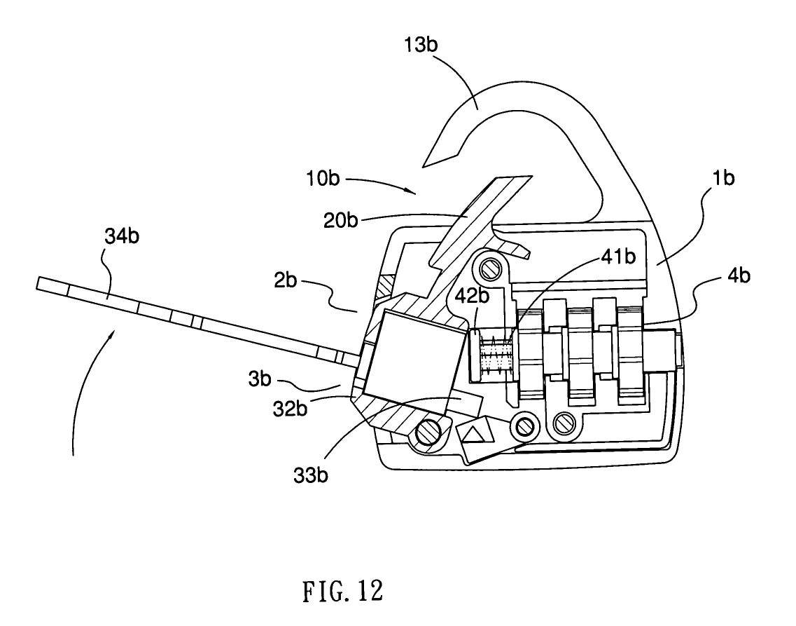

FIG. 11 and FIG. 11A shows that the protrusion 33b is rotated away from the retaining part 42b by operating the lock core 31b of the first locking mechanism 3b via the key 34b. In this state, the press-button 32b of the switch member 2b can be pressed. In the meantime, the locking portion 20b can swing to the second position for opening the breach 10b, so as to release the switch member 2b, as shown in FIG. 12. Accordingly, the switch member 2b can also be released for movement from the first position to the second position by the first locking mechanism 3b.

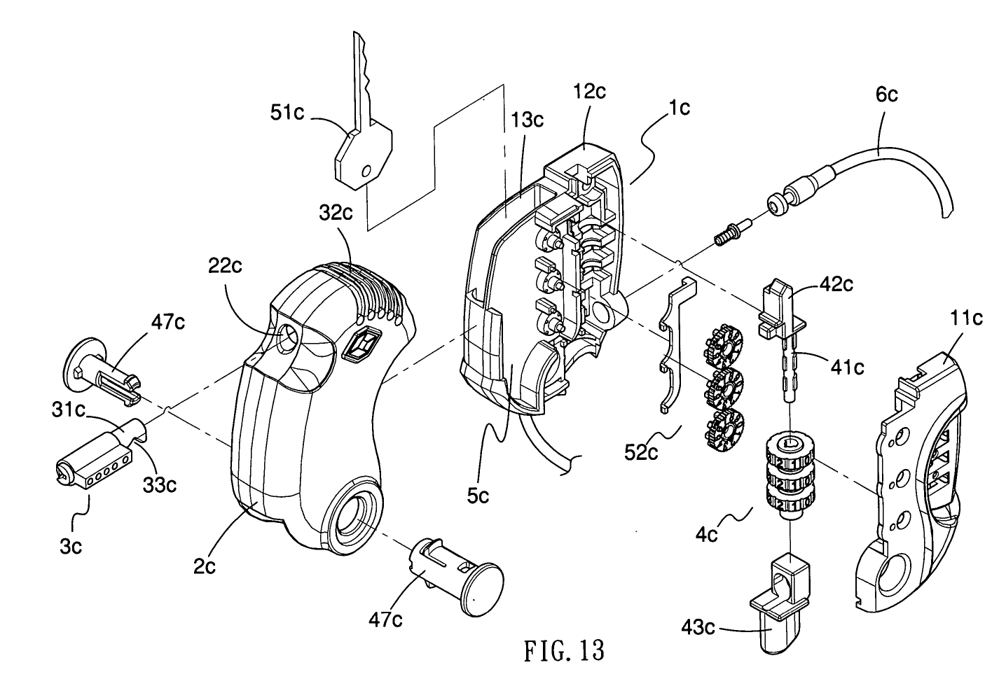

FIGS. 13 to 21 show a dual locking device as a fourth embodiment of the present invention. It should be noted that the dual locking device herein has an unlocking unit 5c for unlocking a luggage case (not shown). In this embodiment, the description does not try to explain how to unlock the luggage case, but how to open the unlocking unit 5c by the dual locking device. This means that the fourth embodiment focuses on the unlocking unit 5c which can be opened by either one of two locking mechanisms of the dual locking device.

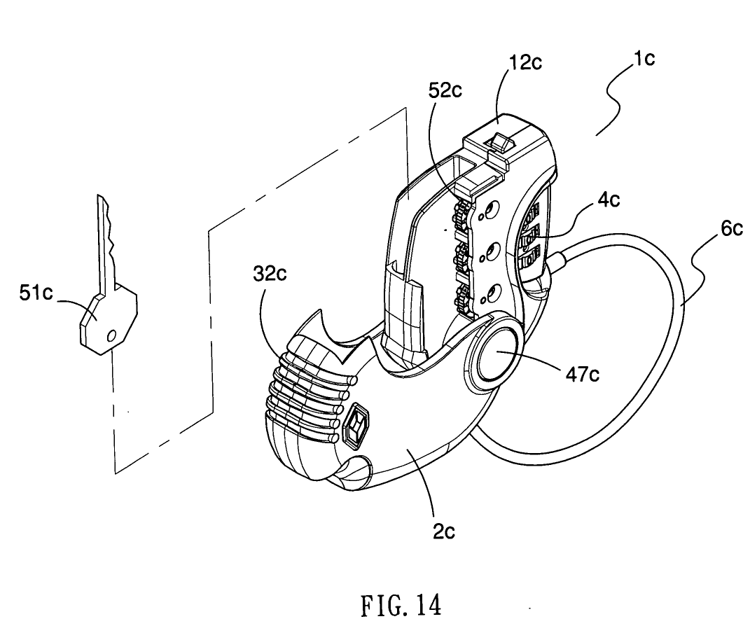

In FIG. 13, the dual locking device, namely a cable lock according to the fourth embodiment, comprises a housing 1c, the unlocking unit 5c, a switch member 2c, the first locking mechanism 3c and the second locking mechanism 4c. The housing Ic is formed by combining two casings 11c, 12c. The unlocking unit 5c is arranged in the housing 1c and includes a key 51c installed in a storage room 13c of the housing 1c. The switch member 2c has a top formed with a press-button 32c and a bottom swayably mounted on the housing 1c by a pivot 47c. Moreover, the switch member 2c defines a channel 22c for receiving the first locking mechanism 3c. The switch member 2c can be released and opened for movement between a first position for blocking the unlocking unit 5c and a second position with respect to the housing 1c for opening the unlocking unit 5c, as shown in FIG. 14, by operating the press-button 32c.

In the fourth embodiment, similar to the third embodiment, the first locking mechanism 3c is a key lock mounted on the switch member 2c; and the second locking mechanism 4c is a combination lock mounted on the housing 1c.

In FIG. 13, the first locking mechanism 3c, namely the key lock, includes a lock core 31c which defines with a notch 33c therein. The lock core 31c can be rotated by a specific key (not shown) so as to change the position of the notch 33c. The second locking mechanism 4c, namely the combination lock, includes a movable shaft 41c, a retaining part 42c and a button 43c. The retaining part 42c is mounted on the movable shaft 41c and has an end engageable with the notch 33c of the lock core 31c of the first locking mechanism 3c. The retaining part 42c is movable only after setting unlocking codes of the second locking mechanism 4c.

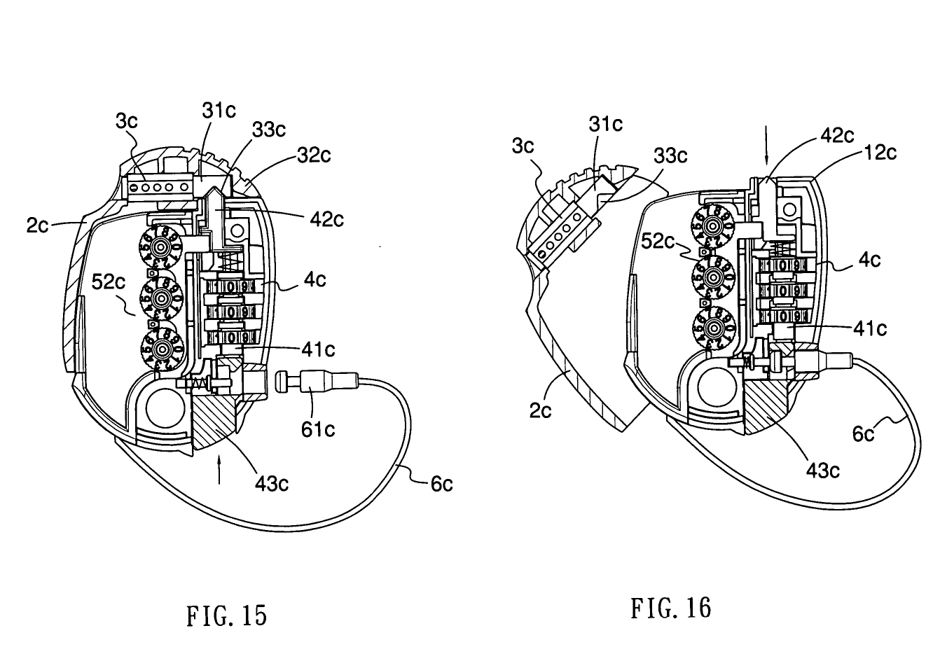

As shown in FIG. 15, the retaining part 42c is engaged with the notch 33c. After the unlocking codes of the second locking mechanism 4c are set, the switch member 2c can be sway away from the housing 1c to the second position, as shown in FIG. 16 by pressing the retaining part 42c of the second locking mechanism 4c. Thus, the switch member 2c is released and opened for movement from the first position to the second position with respect to the housing 1c by the second locking mechanism 4c.

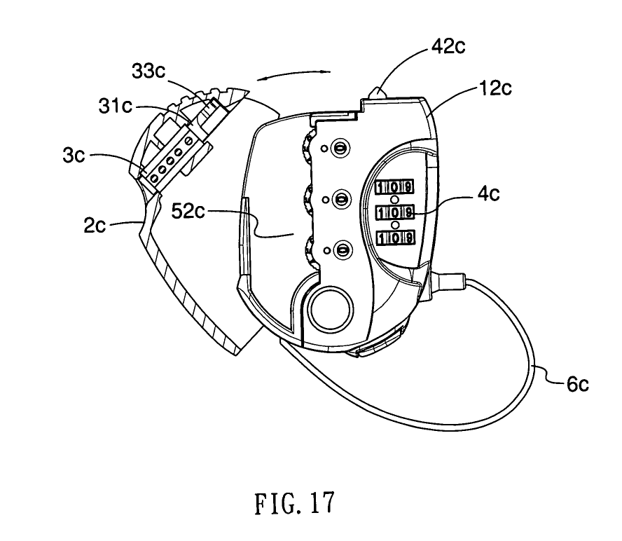

FIG. 17 shows that when the lock core 31c is rotated by operating the specific key (not shown), the notch 33c is accordingly disengaged with the retaining part 42c, and the switch member 2c can then sway away from the housing 1c to the second position. Thus, the switch member 2c can also be released and opened for movement from the first position to the second position with respect to the housing 1c by the first locking mechanism 3c.

Furthermore, the unlocking unit 5c further includes a combination indicator 52c installed in the housing Ic for indicating a set of unlocking codes corresponding to a combination locking mechanism of the luggage case (not shown). The combination indicator 52c is resettable when the second locking mechanism 4c is unlocked. The key 51c is provided for a key locking mechanism of the luggage case (not shown).

Referring to FIG. 15, an end of the button 43c is connected to the movable shaft 41c. When the second locking mechanism 4c is unlocked, the button 43c can be pressed to release an end 61c of a cable 6c of the dual locking device so that the dual locking device can be removed from the luggage case.

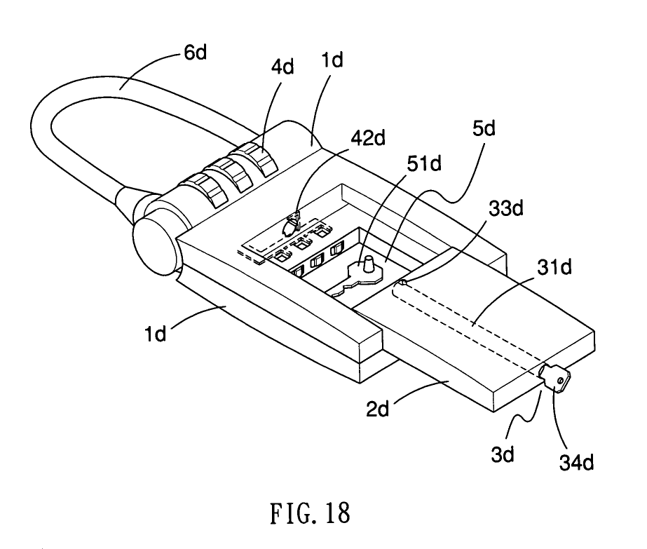

FIG. 18 also shows a dual locking device as a fifth embodiment of the present invention. Similar to the fourth embodiment, the dual locking device of the fifth embodiment is provided for opening an unlocking unit 5d by either a first locking mechanism 3d or a second locking mechanism 4d. Additionally, the dual locking device comprises a housing 1d, a switch member 2d, the first locking mechanism 3d, the second locking mechanism 4d and the unlocking unit 5d which includes a key 51d for unlocking a key locking mechanism of a luggage case (not shown).

In the fifth embodiment, the first locking mechanism 3d is a key lock mounted on the switch member 2d; and the second locking mechanism 4d is a combination lock mounted on the housing 1d. The housing 1d has a room for receiving the key 51d of the unlocking unit 5d. A cable 6d is detachably connected with the housing 1d so as to allow the dual locking device to be hung on any object. More specifically, the cable 6d is detached from the housing 1d only after the second locking mechanism 4d is unlocked. The switch member 2d is slidably mounted on the housing 1d and movable from a first position to cover the key 51d to a second position with respect to the housing 1d to uncover the key 51d only after either the first locking mechanism 3d or the second locking mechanism 4d is unlocked.

Additionally, the first locking mechanism 3d includes a lock core 31d which is formed with a protrusion 33d. The second locking mechanism 4d includes a retaining part 42d which is engageable with the protrusion 33d. Only if the second locking mechanism 4d is unlocked by setting a set of unlocking codes, the protrusion 33d can be released from the retaining part 42d, thereby the switch member 2d can then be moved to the second position to uncover the key 51d. In addition, the first locking mechanism 3d can be unlocked by operating a specific key 34d so as to release the protrusion 33d from the retaining part 42d. Accordingly, the switch member 2d can be moved from the first position to the second position with respect to the housing 1d.

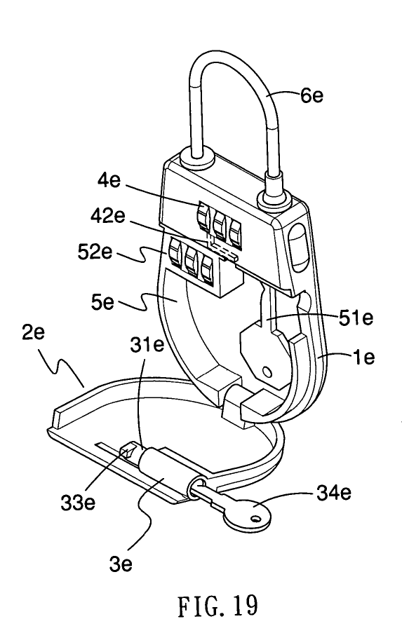

A sixth embodiment of the present invention is shown in FIG. 19. Similar to the fourth embodiment, the sixth embodiment shows a dual locking device which is provided for opening an unlocking unit 5e by either one of two locking mechanisms arranged within the dual locking device. The dual locking device comprises a housing 1e, a switch member 2e, a first locking mechanism 3e, a second locking mechanism 4e and the unlocking unit 5e which includes a key 51e and a combination indicator 52e for opening an object having a key lock and a combination lock.

In the sixth embodiment, similar to the fourth embodiment, the first locking mechanism 3e is a key lock mounted on the switch member 2e; and the second locking mechanism 4e is a combination lock mounted on the housing 1e. The housing 1e has a room for receiving the key 51e of the unlocking unit 5e. A cable 6e is detachably connected with the housing 1e for allowing the dual locking device to be hung on any object. The cable 6e can be disengaged with the housing 1e after the second locking mechanism 4e is unlocked. The switch member 2e is pivotally connected with the housing 1e and movable from a first position to cover the unlocking unit 5e to a second position with respect to the housing 1e to uncover the unlocking unit 5e only after either the first locking mechanism 3e or the second locking mechanism 4e is unlocked.

The first locking mechanism 3e includes a lock core 31e which is formed with a protrusion 33e. The second locking mechanism 4e includes a retaining part 42e which is engageable with the protrusion 33e. Only if the second locking mechanism 4d is unlocked by setting a set of unlocking codes, the protrusion 33e can be released from the retaining part 42e, thereby the switch member 2e can then be moved to the second position to uncover the unlocking unit 5e. In addition, the first locking mechanism 3e can be unlocked by operating a specific key 34e so as to release the protrusion 33e from the retaining part 42e. Accordingly, the switch member 2e can be moved from the first position to the second position with respect to the housing 1e.

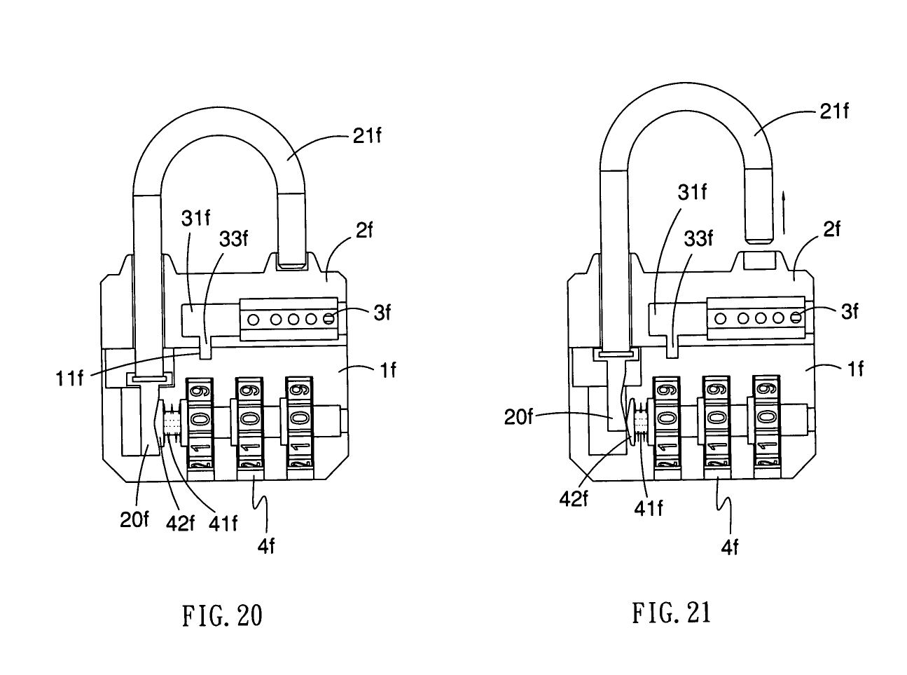

FIGS. 20 to 22 further show a dual locking device as a seventh embodiment of the present invention. In FIG. 20, the dual locking device, namely a padlock, comprises a housing 1f, a switch member 2f, a first locking mechanism 3f and a second locking mechanism 4f. In the seventh embodiment, the first locking mechanism 3f is a key lock mounted on the switch member 2f; and the second locking mechanism 4f is a combination lock mounted on the housing 1f. The switch member 2f is movably mounted on the top of the housing 1f and includes a shackle 21f mounted thereon. The shackle 21f has an end formed with a locking portion 20f.

Additionally, the first locking mechanism 3f includes a lock core 31f which is formed with a protrusion 33f corresponding to a breach 11f of the housing 1f. The second locking mechanism 4f includes a movable shaft 41f and a retaining part 42f which is engageable with the locking portion 20f of the shackle 21f of the switch member 2f. In FIG. 21, when the second locking mechanism 4f is unlocked by setting a set of unlocking codes, the locking portion 20f can be moved against the movable shaft 41f and released from the retaining part 42f of the second locking mechanism 4f, thereby the shackle 21f can then be pulled up to a free position.

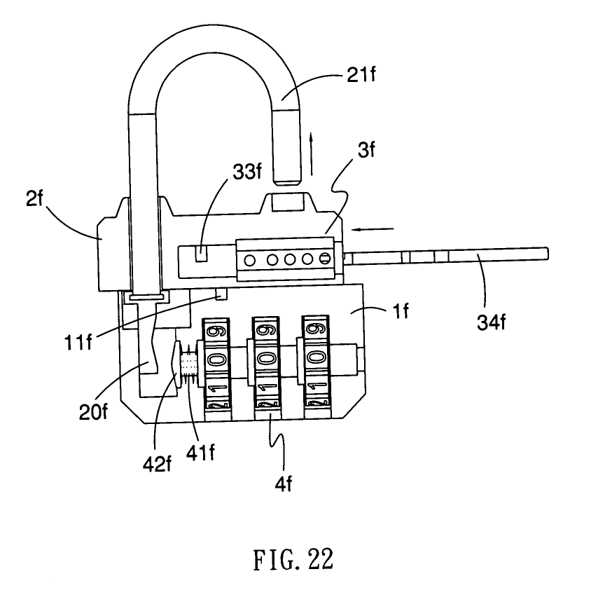

Furthermore, the first locking mechanism 3f can be unlocked by operating a specific key 34f so as to release the protrusion 33f from the breach 11f of the housing 1f. Accordingly, the switch member 2f is movable as shown in FIG. 22 to move from a first position to a second position with respect to the housing 1f so that the shackle 21f can be moved to a free position. Therefore, the dual locking device of the seventh embodiment also shows the switch member 2f can be moved by either the first locking mechanism 4f or the second locking mechanism 3f.

Numerous characteristics and advantages of the invention have been set forth in the foregoing description, together with details of the structure and function of the invention, and the novel features thereof are pointed out in appended claims. The disclosure, however, is illustrative only, and changes may be made in detail, especially, in matters of shape, size and arrangement of parts, materials and the combination thereof within the principle of the invention, to the full extent indicated by the broad general meaning of the terms in which the appended claims are expressed.

What is claimed is:

1. A dual locking device comprising:
a housing;
a switch member, arranged to be capable of moving between a first position and a second position with respect to the housing;
a first locking mechanism, mounted on the switch member; and
a second locking mechanism, mounted on the housing;
wherein the switch member can be released for movement from the first position to the second position by either the first locking mechanism or the second locking mechanism.

2. The dual locking device of claim 1, wherein the first locking mechanism is arranged to be unlocked by a set of unlocking codes, and the second locking mechanism is arranged to be unlocked by a key.

3. The dual locking device of claim 1, wherein the first locking mechanism is arranged to be unlocked by a key, and the second locking mechanism is arranged to be unlocked by a set of unlocking codes.

4. The dual locking device of claim 2, wherein the second locking mechanism includes a retaining part for releasing the switch member after operating the key.

5. The dual locking device of claim 3, wherein the second locking mechanism includes a retaining part for releasing the switch member after setting the unlocking codes.

6. The dual locking device of claim 1, wherein the housing includes:
a first casing; and
a second casing, coupled to the first casing.

7. The dual locking device of claim 4, wherein the housing includes:
a first casing; and
a second casing, coupled to the first casing.

8. The dual locking device of claim 5, wherein the housing includes:
a first casing; and
a second casing, coupled to the first casing.
